(19) United States
(12) Patent Application Publication
(10) Pub. No.: US 2024/0176045 A1
(43) Pub. Date: May 30, 2024

(54) NOWCASTING USING GENERATIVE NEURAL NETWORKS

(71) Applicant: DeepMind Technologies Limited, London (GB)

(72) Inventors: Suman Ravuri, London (GB); Karel Lenc, London (GB); Piotr Wojciech Mirowski, London (GB); Remi Roger Alain Paul Lam, London (GB); Matthew James Willson, London (GB); Andrew Brock, London (GB)

(21) Appl. No.: 18/277,729

(22) PCT Filed: Feb. 16, 2022
(86) PCT No.: PCT/EP2022/053834

§ 371 Date: Aug. 17, 2023

Related U.S. Application Data
(60) Provisional application No. 63/150,509, filed on Feb. 17, 2021.

(51) Int. Cl. G01W 1/10; G06N 3/0475

(52) U.S. Cl. CPC G01W 1/10; G06N 3/0475

(57) ABSTRACT

Methods, systems, and apparatus, including computer programs encoded on computer storage media, for precipitation nowcasting using generative neural networks. One of the methods includes obtaining a context temporal sequence of a plurality of context radar fields characterizing a real-world location, each context radar field characterizing the weather in the real-world location at a corresponding preceding time point; sampling a set of one or more latent inputs by sampling values from a specified distribution; and for each sampled latent input, processing the context temporal sequence of radar fields and the sampled latent input using a generative neural network that has been configured through training to process the temporal sequence of radar fields to generate as output a predicted temporal sequence comprising a plurality of predicted radar fields, each predicted radar field in the predicted temporal sequence characterizing the predicted weather in the real-world location at a corresponding future time point.

### BACKGROUND

This specification relates to using neural networks to perform weather nowcasting e.g. precipitation nowcasting.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a system implemented as computer programs on one or more computers in one or more locations that performs weather e.g., precipitation nowcasting using a generative neural network.

Weather, e.g., precipitation, nowcasting generally refers to high-resolution forecasting of weather, e.g. precipitation such as rainfall, hydrometeors, or both, in the near future relative to the current time at which the forecast is generated, e.g., up to two hours ahead of the current time.

Particular embodiments of the subject matter described in this specification can be implemented so as to realize one or more of the following advantages.

Precipitation nowcasting, i.e., the high-resolution forecasting of precipitation up to two hours ahead, supports the real-world socio-economic needs of many sectors reliant on weather-dependent decision-making. Nowcasting informs the operations of a wide variety of sectors, including emergency services, energy management, retail, flood early-warning systems, air traffic control and marine services.

For nowcasting to be useful in these applications, the forecast must provide accurate predictions across multiple spatial and temporal scales, account for uncertainty and be verified probabilistically, and perform well on heavier precipitation events that are rarer, but more critically affect human life and economy.

State-of-the-art operational nowcasting methods typically advect precipitation fields with radar-based wind estimates, and struggle to capture important non-linear events such as convective initiations. Existing deep learning methods use radar to directly predict future rain rates, free of physical constraints. While they accurately predict low-intensity rainfall, their operational utility is limited because their lack of constraints produces blurry nowcasts at longer lead times, yielding poor performance on more rare medium-to-heavy rain events.

To address these challenges, the described techniques use a deep generative model for the probabilistic nowcasting of, e.g., precipitation from radar. The described model produces realistic and spatio-temporally consistent predictions over regions up to 1536 km×1280 km and with lead times from 5-90 min ahead of the current time. The described model generates nowcasts that are skillful without resorting to blurring and, in some implementations, can generate multiple skillful nowcasts for a single observation, i.e., to capture the inherent uncertainty in nowcasting. The described techniques provide probabilistic predictions that improve forecast value and support operational utility, and at resolutions and lead times where alternative methods struggle.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example nowcasting system.

FIG. 2 is a diagram of an example architecture for the generative neural network.

FIG. 3 is a diagram of an example training framework for training the generative neural network.

FIG. 4 is a flow diagram of an example process for performing nowcasting for a given real-world location.

Like reference numbers and designations in the various drawings indicate like elements.

### DETAILED DESCRIPTION

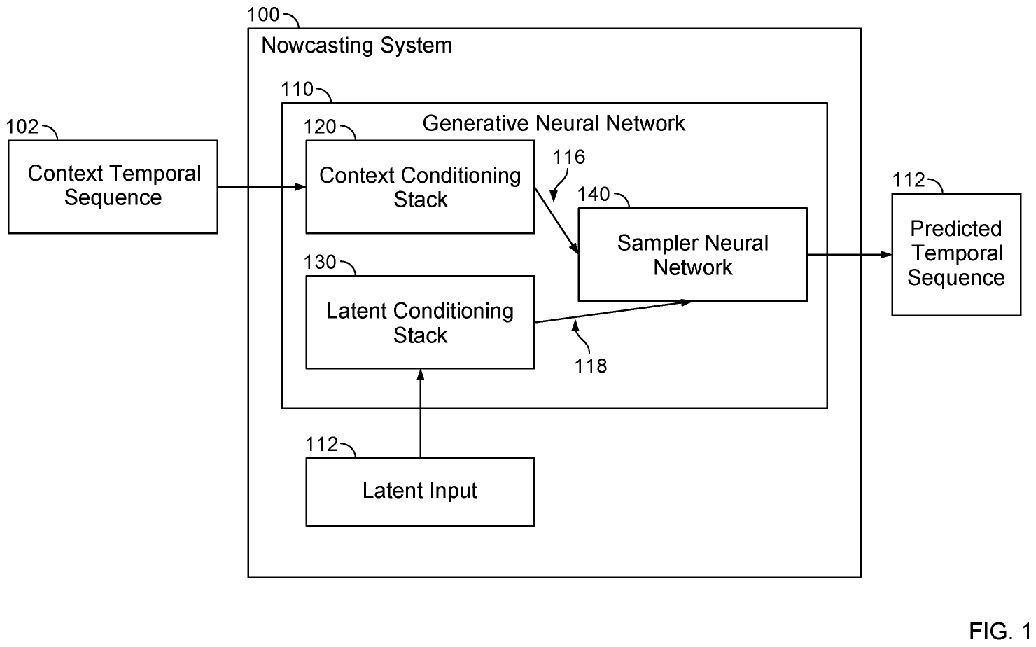

FIG. 1 shows an example nowcasting system 100. The nowcasting system 100 is an example of a system implemented as computer programs on one or more computers in one or more locations, in which the systems, components, and techniques described below can be implemented.

The system 100 performs nowcasting, e.g. precipitation nowcasting, using a generative neural network 110.

As described above, precipitation nowcasting generally refers to high-resolution forecasting of precipitation, e.g., rainfall, hydrometeors, or both, in the near future, e.g., up to two hours ahead of the current time. Nowcasting may also refer to, e.g., predicting wind conditions.

To perform nowcasting for a given real-world location, the system 100 obtains a context temporal sequence 102.

The context temporal sequence 102 includes a plurality of radar fields that each characterize the same real-world location, i.e., the real-world location for which nowcasting is to be performed, with each radar field characterizing the weather in the real-world location at a corresponding, different preceding time point. That is, the context temporal sequence 102 characterizes the weather in the real-world location over a recent time window ending at the current time at which the nowcasting is being performed.

Radar fields that are included in a context temporal sequence 102 will be referred to in this specification as “context radar fields.”

In other words, the system 100 obtains context radar fields that have already been measured in the (recent) past at the real-world location of interest. For example, the context radar fields can cover the most recent 20 minutes of radar measurements at the real-world location, e.g., can include four radar fields spaced at five minute intervals.

A radar field has values for points in physical space (i.e. it is a field), with values determined by radar. In some particular implementations, a radar field is a two-dimensional spatial grid, i.e., an image, that is overlaid over a real-world location at a given resolution and that includes a precipitation rate for each grid cell of the spatial grid. That is, each radar field includes a respective precipitation rate for each of a plurality of grid cells that each correspond to a respective region of the real-world location at the given resolution.

For the context radar fields, each precipitation rate is a measured precipitation rate that represents a precipitation rate that was measured at the corresponding region at the corresponding preceding time point for the context radar field. For example, the precipitation rate can be a measure of rainfall, hydrometeors, or both at the corresponding region at the corresponding preceding time point.

While other approaches may take in additional inputs, e.g., satellite data, in addition to radar fields that show measured precipitation, the system 100 can perform nowcasting only from the context radar fields, i.e., only from precipitation as measured by radar, and does not need to receive or use any additional data that characterizes the real-world location. That is, the context radar fields are the only information that characterizes the real-world location that the system 100 uses to perform nowcasting for the real-world location.

As a particular example, the context radar fields can be of size 1536×1280, with each grid cell corresponding to a 1 km by 1 km region in the real-world location and including the measured precipitation rate at the corresponding location, e.g., in millimeters per hour.

To perform nowcasting using the context temporal sequence 102, the system 100 samples, i.e. determines, a set of one or more latent inputs 104 by sampling values from a specified distribution.

That is, in some cases the system 100 is only configured to generate a single plausible realization of future precipitation at the real-world location and therefore samples only a single latent input 104.

In some other cases, the system 100 is configured to generate multiple realizations of future precipitation and therefore samples multiple latent inputs 104.

To sample a given latent input 104, the system 100 samples a respective value for each entry of a tensor having a specified dimension from the specified distribution. As a particular example, the tensor can have dimensionality h/a×w/a×b, where h×w×1 are the dimensions of latent input, a “context latent field”, and a and b are hyperparameters of the system.

The system 100 can sample each value in the latent input 104, i.e., the value for each entry of the tensor, independently from the specified distribution.

The system 100 can use any appropriate distribution as the specified distribution. As a particular example, the specified distribution can be a Gaussian distribution, e.g., with mean zero and standard deviation one or standard deviation of two.

For each sampled latent input 104, the system 100 processes the context temporal sequence 102 of radar fields and the sampled latent input 104 using the generative neural network 110.

The generative neural network 110 is a neural network that has been configured through training to process the context temporal sequence 102 to generate as output a predicted temporal sequence 112.

The predicted temporal sequence 112 includes a plurality of predicted radar fields, with each predicted radar field in the predicted temporal sequence 112 characterizing the predicted weather in the real-world location at a different corresponding future time point, i.e., a time point that is after the time corresponding to the most recent context radar field in the context temporal sequence 102.

The predicted radar fields can each correspond to a different time point that is within 90 or 120 minutes of the most recent context radar field in the context temporal sequence 102. As a particular example, the temporal sequence 112 can include 18 radar fields spaced at five minute intervals, i.e., so that the first radar field in the sequence 112 is five minutes after the current time and the last radar field in the sequence 112 is 90 minutes after the current time.

Each predicted radar field in the predicted temporal sequence 112 includes a respective predicted precipitation rate for each of the plurality of grid cells that each correspond to a respective region of the real-world location at the given resolution, i.e., the same resolution as the context radar fields. The respective predicted precipitation rate for each of the grid cells represents a precipitation rate that is predicted to be measured at the corresponding region at the corresponding future time point, e.g., a measure of predicted rainfall, predicted hydrometeors, or both at the corresponding region at the corresponding future time point.

For example, each predicted radar field can be of size 1536×1280, with each grid cell corresponding to a 1 km by 1 km region in the real-world location and including the predicted precipitation rate at the corresponding location, e.g., in millimeters per hour, at the corresponding time.

When multiple predicted temporal sequences 112 are generated, i.e., one sequence 112 for each of multiple different latent inputs 104, each predicted temporal sequence 112 represents a different possible realization of future precipitation at the real-world location.

That is, the system 100 can model different plausible realizations of future precipitation given the same context temporal sequence 102 by conditioning the generative neural network 110 on different latent inputs 104. This can allow the outputs of the system 100 to capture the inherent uncertainty in performing nowcasting while still ensuring that the predictions within each individual temporal sequence 112 are consistent, i.e., represent a single, plausible realization of future precipitation.

Generally, to generate a given predicted temporal sequence 112, the generative neural network 110 processes the context temporal sequence 102 using a context conditioning convolutional stack 120, i.e. a stack of convolutional neural network layers, to generate a respective context feature representation 116 at each of a plurality of spatial resolutions and processes the latent input 104 using a latent conditioning convolutional stack 130 to generate a latent feature representation 118.

The neural network 110 then generates the predicted temporal sequence 112 from the context feature representations 116 and the latent feature representation 118 by processing the context feature representations 116 and the latent feature representation 118 using a sampler neural network 140.

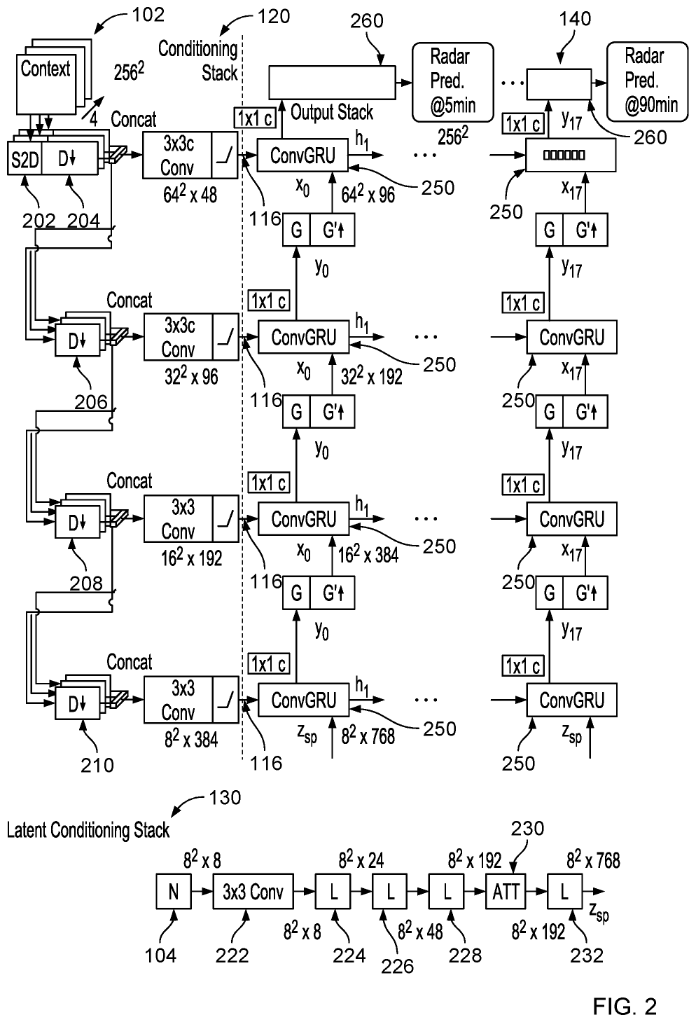

This processing will be described in more detail below with reference to FIG. 2.

Prior to using the neural network 110 to perform nowcasting, the system 100 or a training system trains the neural network 110 on training data that includes sequences of observed radar fields.

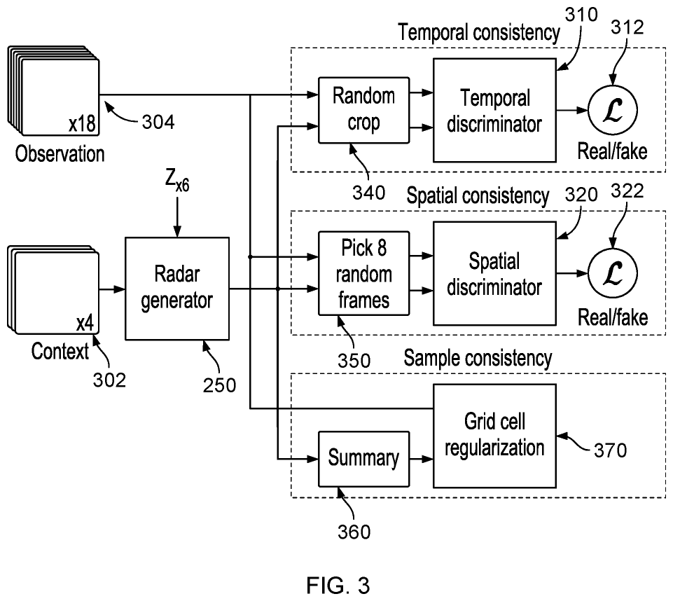

Training the neural network 110 will be described in more detail below with reference to FIG. 3.

Once the system 100 generates the one or more predicted sequences 112, the system 100 can use them for any of a variety of purposes. For example, the system 100 can provide the sequence 112 for presentation to a user on a user computer, e.g., to allow the user to visualize the predicted future weather in a given real-world location and to allow the user to effectively make operational decisions that may depend on the nowcasts.

FIG. 2 shows an example architecture of the context conditioning convolutional stack 120, the latent conditioning convolutional stack 130, and the sampler neural network 140.

As described above, the context conditioning stack 120 processes the context temporal sequence 102 to generate the context feature representations 116.

In the example of FIG. 2, the temporal sequence 102 includes four 256×256 radar fields that each characterize the actual, observed precipitation in the real-world region at a different time.

Further, in the example of FIG. 2, the context feature representations 116 include a respective context feature representation 116 at each of four different spatial resolutions: 64×64×48 (where 64×64 is the spatial resolution and 48 is the number of channels in the representation), 32×32×96, 16×16×192, and 8×8×384.

Generally, the context conditioning stack 120 can have any appropriate convolutional architecture that allows the stack 120 to map a sequence of radar fields to multiple different context feature representations at different resolutions using convolutions and, optionally, other operations that can operate on variable size inputs.

As a particular example and as shown in FIG. 2, the context conditioning stack 120 applies a space-to-depth (S2D) operation 202 to each context radar field to generate a converted input that has a smaller spatial dimensionality but a larger number of channels (larger depth dimension). For example, the S2D operation 202 can stack 2×2 patches into the channel dimension to convert each 256×256×1 radar field to a 128×128×4 converted input.

The stack 120 then processes each converted input using a sequence of downsampling residual blocks D↓ 204, 206, 208, and 210.

Each downsampling residual block decreases the spatial resolution of the input to the block while increasing the number of channels. For example, in the example of FIG. 2, each downsampling residual block decreases the spatial resolution by a factor of two while increasing the number of channels by a factor of two.

The downsampling residual blocks 204, 206, 208, and 210 can have any appropriate convolutional architecture that applies a residual connection and that results in a downsampled output. As a particular example, each downsampling residual block can include a residual branch that includes a 1×1 convolution and a main branch that includes two 3×3 convolutions.

For each downsampling residual block in the sequence, the stack 120 concatenates the outputs of the residual block for each of the converted inputs across the channel dimension and applies a convolution, e.g., a 3×3 spectrally normalized convolution, to the concatenated outputs to reduce the number of channels, e.g., by a factor of two, followed by an activation function, e.g., a rectified linear unit, to generate the context feature representation that has the corresponding spatial resolution.

As described above, the latent conditioning stack 130 processes the latent input 104 to generate the latent feature representation 118.

In the example of FIG. 2, the latent input 104 is an 8×8×8 feature map and the latent feature representation 118 is an 8×8×768 feature map.

Generally, the latent conditioning stack 130 can have any appropriate convolutional architecture that allows the stack 130 to map a feature map to a different feature map having the same spatial dimensions but a larger number of channels.

As a particular example and as shown in FIG. 2, the latent conditioning stack 130 can process the latent input 104 through a convolutional layer, e.g., a 3×3 convolutional layer 222, followed by three residual blocks (L blocks 224, 226, and 228), a spatial attention module 230, and a final residual block (L Block 232) to generate the latent feature representation 118.

The residual blocks 224, 226, 228, and 232 can have any appropriate convolutional architecture that applies a residual connection that maintains the spatial resolution of the input to the block. As a particular example, each residual block can include a residual branch that includes a 1×1 convolution and a main branch that includes two 3×3 convolutions.

Including the spatial attention module 230 in the latent conditioning stack between the residual blocks can allow the model to be more robust across different types of regions and events, and can provide an implicit regularization to prevent overfitting during training.

As described above, the sampler neural network 140 processes the context feature representations 116 and the latent representation 118 to generate the predicted temporal sequence 112.

The sampler neural network 140 includes a sequence of convolutional recurrent neural networks (convRNN) 250 and an output convolutional stack 260. In the example of FIG. 2, each convRNN 250 is a convolutional gated recurrent unit (convGRU). As another example, the convolutional recurrent neural networks (convRNN) can have a different recurrent architecture, e.g., a convolutional long short-term memory (convLSTM) architecture.

Each convRNN 250 operates at the spatial resolution of a different one of the context feature representations 116. Thus, in the example of FIG. 2, there are four convRNNs 250 that operate at four different spatial resolutions: 64×64, 32×32, 16×16, and 8×8.

To generate the first predicted radar field at the first future time point in the predicted temporal sequence 112, for each spatial resolution, the sampler neural network 140 initializes the hidden state of the corresponding convolutional recurrent neural network (convRNN) in the sequence of convRNNs 250 that operates at the spatial resolution to be the respective context feature representation at the spatial resolution. That is, for each convRNN, the sampler neural network 140 initializes the hidden state of the convRNN to be equal to the context feature representation that has the same spatial resolution as the hidden state of the convRNN.

The sampler neural network 140 then processes the latent feature representation 118 through the sequence of convRNNs 250 in accordance with the respective hidden states of each of the convRNNs to (i) update the respective hidden states of each of the convRNNs 250 and (ii) generate an output feature representation 252 for the first future time point. Generally, the output feature representation 252 has a smaller spatial dimensionality but more channels than the radar fields in the predicted sequence 112.

As part of processing the latent feature representation 118 through the sequence of convRNNs 250, for each convRNN 250, the neural network 140 upsamples the output of the convRNN. That is, for each convRNN other than the last convRNN in the sequence, the neural network 140 upsamples the output to the spatial resolution of the next convRNN in the sequence 250 and for the last convRNN in the sequence, the neural network 140 upsamples the output to the spatial resolution of the output feature representation, i.e., of the input to the output stack 260. In the example of FIG. 2, the neural network 140 performs the upsampling by applying one spectrally normalized convolution followed by two residual blocks.

The sampler neural network 140 then processes the output feature representation 252 for the first future time point using the output convolutional stack 260 to generate the predicted radar field at the first future time point.

The output convolutional stack 260 can have any appropriate architecture that allows the stack 260 to map the output feature representation 252 to a radar field that has the spatial dimensionality of the radar fields in the sequence 112, i.e., 256×256×1 in the example of FIG. 2.

In the example of FIG. 2, the output convolutional stack 260 applies batch normalization, a ReLU and a 1×1 convolution to the upsampled output of the last convRNN 250 to generate an output that has the same number of elements as, but a different shape from, the predicted radar fields. In the example of FIG. 2, the output has size 128×128×4. The output convolution stack 260 can then apply a depth-to-space (DTS) to reshape the output to have the spatial dimensionality of the radar fields.

For each future time point in the temporal sequence after the first future time point, the neural network 140 processes the latent feature representation 118 through the sequence of convRNNs 250 in accordance with respective hidden states of each of the convRNNs as of the preceding future time point in the temporal sequence to (i) update the respective hidden states of each of the convRNNs and (ii) generate an output feature representation for the future time point and then processes the output feature representation for the future time point using the output convolutional stack to generate the predicted radar field at the future time point.

That is, the neural network 140 processes the latent feature representation 118 in the same manner as for the first future time point, but with the hidden states of the convRNNs set to the states that were generated as a result of the processing for the preceding future time point in the sequence.

By having the sampler neural network 140 operate on multiple context representations at different spatial resolutions as described above, the sampler neural network 140 can make effective use of the context radar fields, overcoming a common challenge for conditional generative models. That is conditional generative models that are powerful enough to generate high-quality high-resolution outputs typically struggle to effectively make use of context (and can, e.g., ignore the context and generate outputs almost entirely using the information that is encoded in the weights of the generative model). By employing multiple context representations at different spatial resolutions, the neural network 110 generates output temporal sequences 112 that are both internally consistent and that accurately predict the future weather given the input context sequence 102.

As described above, prior to deploying the generative neural network 110 to perform nowcasting, the system 100 or another training system trains the neural network 110 on training data that includes multiple sequences of observed radar fields.

Generally, the training system can train the generative neural network 110 using any appropriate supervised learning technique, e.g., to optimize any appropriate objective that measures the quality of predicted radar fields generated by the neural network 110 relative to corresponding observed radar fields found in the training data.

Suitable training data is released yearly by the UK Met Office under a creative commons license and can be obtained from the Data Provisioning Team. As another example, a multi-radar multi-sensor (MRMS) dataset is available, with appropriate agreements, from the US National Oceanic and Atmospheric Administration. The data may be pre-processed to create a dataset that is more representative of heavy precipitation e.g. by sub-sampling using an importance sampling approach that favors higher rainfall examples.

As a particular example, the training system can train the neural network 110 jointly with one or more discriminator neural networks on training data that includes sequences of observed radar fields to optimize a generative adversarial networks (GAN) objective. The discriminator neural network(s) are then only needed during training.

One example of training to optimize a GAN objective is described below with reference to FIG. 3.

Where both the context conditioning stack 120 and the latent conditioning stack 130 are convolutional, i.e., are composed entirely of convolutions and other operations that can be applied to variable sized inputs, and can generate variable sized outputs, the training system can operate on and generate smaller radar fields, i.e., radar fields that have smaller spatial dimensionality, during training and the system 100 can generate larger radar fields, i.e., radar fields that have larger spatial dimensionality than those used during training, after training, i.e., after deployment.

Additionally, the training system can use sampled latent inputs that have a smaller dimensionality than the sampled latent inputs after training.

As a particular example, during training, the dimensionality of the radar fields can be h₁×w₁×1 and the dimensionality of the sampled latent inputs can be h₁/a×w₁/a×b. After training, i.e., when performing nowcasting after deployment, the dimensionality of the radar fields can be h₂×w2×1 and the dimensionality of the sampled latent inputs can be h₂/a×w₂/a×b, with h₂ being larger than h₁, and w₂ being larger than w₁.

For example, during training the radar fields can be 256×256×1 and the sampled latents can be 8×8×8. After training, the radar fields can be 1536×1280×1 and the sampled latents can be 48×40×8.

As a particular example, each observed radar field in each observed training sequence can be a 256×256 crop of a corresponding radar field in a sequence of larger, full-size 1536×1280×1 observed radar fields. In some implementations, when performing the cropping, rather than cropping entirely at random, the training system can favor regions with higher precipitation rates, i.e., so that grid cells with higher precipitation rates are more likely to be included in a crop than grid cells with lower precipitation rates.

Training in this manner significantly reduces the amount of memory and processor cycles required to perform training while still allowing the system 100 to make accurate predictions for larger geographic regions at deployment.

FIG. 3 is a diagram of an example training framework for training the generative neural network 110.

In the example of FIG. 3, the training system trains the generative neural network 110 (“generator”) jointly with a temporal discriminator neural network 310 and a spatial discriminator neural network 320.

In particular, the training system trains the neural network 110 by alternating between performing generator training steps in which the generative neural network 110 is updated and discriminator training steps in which the temporal discriminator neural network 310 and the spatial discriminator neural network 320 are updated.

The temporal discriminator neural network 310 measures the temporal consistency of predicted radar fields generated by the neural network 110 relative to corresponding observed radar fields from the training data.

In particular, the temporal discriminator neural network 310 distinguishes sequences of observed radar fields from the training data from sequences of predicted radar fields generated by the generative neural network 110.

That is, the input to the temporal discriminator 310 is a sequence that includes context radar fields concatenated along the time axis to either the predicted radar fields (for generator training steps), or the predictions or targets (for discriminator training steps). The output of the temporal discriminator 310 is a temporal score that represents a likelihood that the input sequence is “real,” i.e., includes observed radar fields, as opposed to “fake,” i.e., includes predictions generated by the generator 110.

The spatial discriminator neural network 320 measures the spatial consistency of predicted radar fields generated by the neural network 110 relative to corresponding observed radar fields from the training data.

In particular, the spatial discriminator neural network 320 distinguishes individual observed radar fields from the training data from individual predicted radar fields generated by the generative neural network 110.

That is, the input to the spatial discriminator 320 is a sequence that includes either predicted radar fields (for generator training steps) or the predicted radar fields or target radar fields (for discriminator training steps). The output of the spatial discriminator 310 is a score that represents a likelihood that the input sequence is “real,” i.e., includes observed radar fields, as opposed to “fake,” i.e., includes predictions generated by the generator 110.

The temporal and spatial discriminators 310 and 320 can have any appropriate architecture that allows the discriminator to map a set of multiple radar fields to a single score. For example, the temporal and spatial discriminators can each be a respective convolutional neural network. Examples of architectures for the spatial and temporal discriminators are described in Luc, P. et al. Transformation-based Adversarial Video Prediction on Large-Scale Data. available on arXiv, 2003.04035, the entire contents of which are hereby incorporated by reference in their entirety.

In particular, to perform a given training step for a given training sequence that includes M+N observed radar fields, the training system uses the first M radar fields in the sequence as training context radar fields 302 and the remaining N observed radar fields in the sequence as target radar fields 304.

The training system then samples multiple latent inputs 306 as described above. In the example of FIG. 3, M is equal to four, N is equal to 18, and 6 latent inputs are sampled.

For each sampled latent input, the training system processes the latent input 306 and the training context radar fields 302 using the generative neural network 110 to generate a sequence that includes N predicted future radar fields, one corresponding to each of the N target radar fields.

When performing a generator training step, the training system applies a random crop 340 to each of the temporal sequences, e.g., to crop each field in the temporal sequence to a fixed size, e.g., 128×128. The training system then processes each cropped sequence using the temporal discriminator 310 to generate a respective temporal score 312 for each cropped sequence that represents the likelihood that the cropped sequence is real.

The training system also selects 350 a random number, e.g., eight, of frames from each generated temporal sequence and then processes the randomly selected frames using the spatial discriminator 320 to generate a respective spatial score 322 for each temporal sequence that represents the likelihood that the temporal sequence is real.

In some implementations, the GAN objective is equal to a sum or a weighted sum of (i) the average of the respective temporal scores 312 and (ii) the average of the respective spatial scores 322.

Optionally, the training system can also incorporate a sample consistency objective into the training of the generative neural network 110, i.e., into each generator training step.

When the sample consistency objective is used, the GAN objective is equal to a sum or a weighted sum of (i) the average of the respective temporal scores 312 and (ii) the average of the respective spatial scores 322 minus the product of a weight hyperparameter and the value of the sample consistency objective.

As shown in FIG. 3, the training system incorporates the sample consistency objective by computing, for each grid cell in each target radar field, a summary 360 of the values for that grid cell in the corresponding generated radar fields, i.e., the radar fields at the corresponding times in each of the multiple generated sequences.

The training system then computes a regularization score 370 by computing, for each grid cell in each target radar field, a likelihood for the value for the grid cell in the target radar field given the summary 360 computed for that grid cell.

The summary 360 for a given grid cell can be computed using any estimate of distributional parameters that allows the computation of the likelihood of the real context. For example, the summary can be a mean or other measure of central tendency of the values of the values for that grid cell and the likelihood can be a difference between the summary and the corresponding value in the target radar field.

The training system then computes the regularization score 370 from these likelihoods. For example, the training system can multiply, for each grid cell, the likelihood computed for the grid cell by the output of a function that biases towards heavier rainfall targets and that takes as input the value for that grid cell in the target radar field to generate a product. The system can then compute the regularization score 370 by computing an l₁ norm of these products across all of the grid cells in all of the target radar fields and then dividing the l₁ norm by the total number of grid cells in all of the target radar fields.

When performing a discriminator training step, the training system also applies a random crop 340 to the target sequence, e.g., to crop each field in the temporal sequence to a fixed size, e.g., 128×128. The training system then processes each cropped sequence, i.e., the cropped sequences for the target sequence and the generated sequences, using the temporal discriminator 310 to generate a respective temporal score 312 for each cropped sequence.

The training system then updates the temporal discriminator 310 using the temporal scores 312, e.g., using an appropriate GAN discriminator training objective, e.g., a hinge loss GAN objective.

The training system also selects 350 a random number, e.g., eight, of frames from each generated temporal sequence and the target sequence and then processes the randomly selected frames using the spatial discriminator 320 to generate a respective spatial score 322 for each temporal sequence and the target sequence.

The training system then updates the spatial discriminator 320 using the spatial scores 322, e.g., using an appropriate GAN discriminator training objective, e.g., a hinge loss GAN objective.

As one illustrative example a GAN objective to be maximized for generator training steps, [symbol] _{G}(0), may be:

[symbol]

_{G}(°)= [symbol] _{X}_{_{1:M+N}}[ [symbol] _{Z}[D(G_{θ}(Z;X_{1:M}))+T({X_{1:M};G_{θ}(Z;X_{1:M})})]]

where the spatial discriminator 320, D_{ϕ} has parameters ϕ, the temporal discriminator 310 T_{ψ} has parameters ψ, the generator 110 G_{θ} has parameters θ, {X; G} denotes the concatenation of two sets of fields, X denotes a radar field of height H and width W (in grid cells), X_{1:M} denotes the set of radar fields at positions 1 through M in the observed sequence, Z denotes a latent input 306, and the expectations are computed by sampling latent inputs as previously described. Optionally the objective may include a regularization score as described above, e.g. with a weight determined by a weight hyperparameter.

As one illustrative example a GAN spatial discriminator loss [symbol] _{D}(ϕ), and GAN temporal discriminator loss [symbol] _{T}(ψ), to be minimized with respect to parameters ϕ and ψ, and where ReLU=max(0, x), may be:

[symbol]

_{D}(ϕ)= [symbol] _{X}_{_{1:M+N}}_{Z}[ReLU(1−D_{ϕ}(X_{M+1:M+N}))+ReLU(1+D_{ϕ}(G_{θ}(Z;X_{1:M})))]

[symbol]

_{T}(ψ)= [symbol] _{X}_{_{1:M+N}}_{Z}[ReLU(1−T_{ψ}(X_{M+1:M+N}))+ReLU(1+T_{ϕ}({X_{1+M}G_{θ}(Z;X_{1:M})})))]

Having the temporal discriminator 310 process a cropped sequence rather than the original sequence of radar fields and only using a subset of the radar fields as input to the spatial discriminator 320 allows the temporal discriminator 310 and the spatial discriminator 320 to be memory efficient, i.e., so that the models fit in memory of the device on which they are deployed during training, while maintaining the quality of the training process.

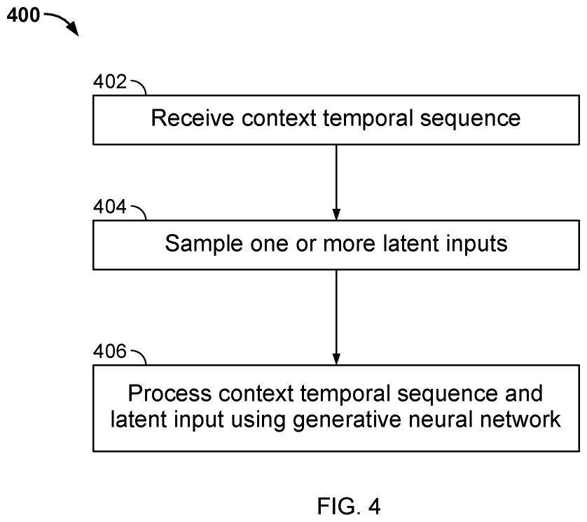

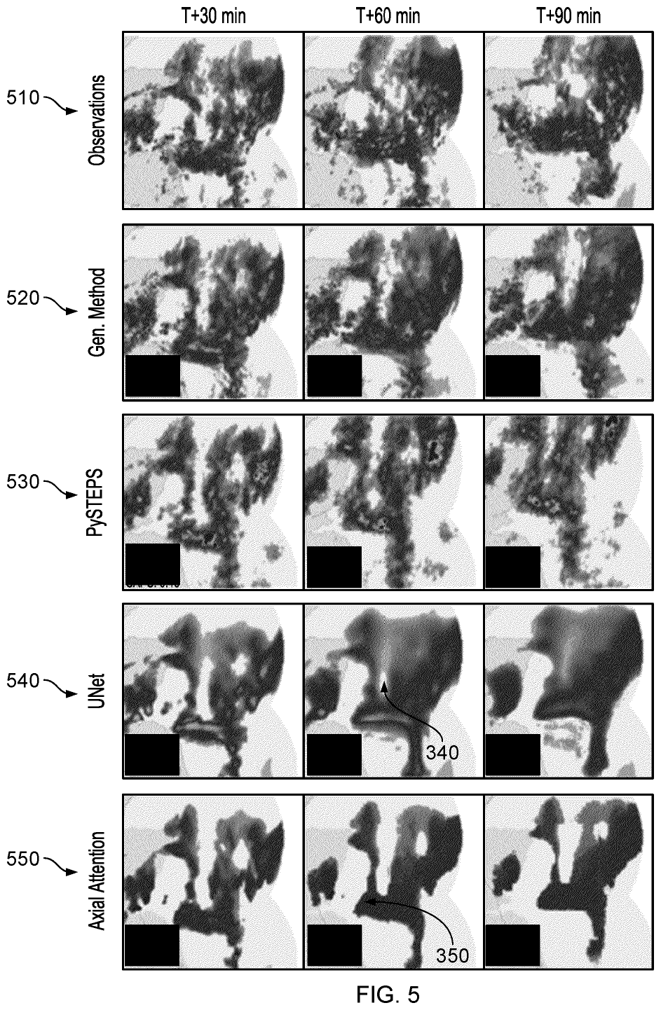

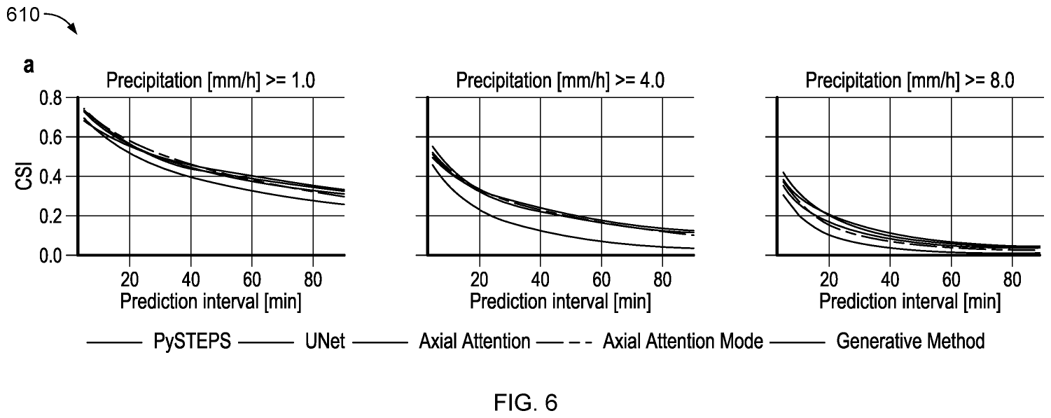

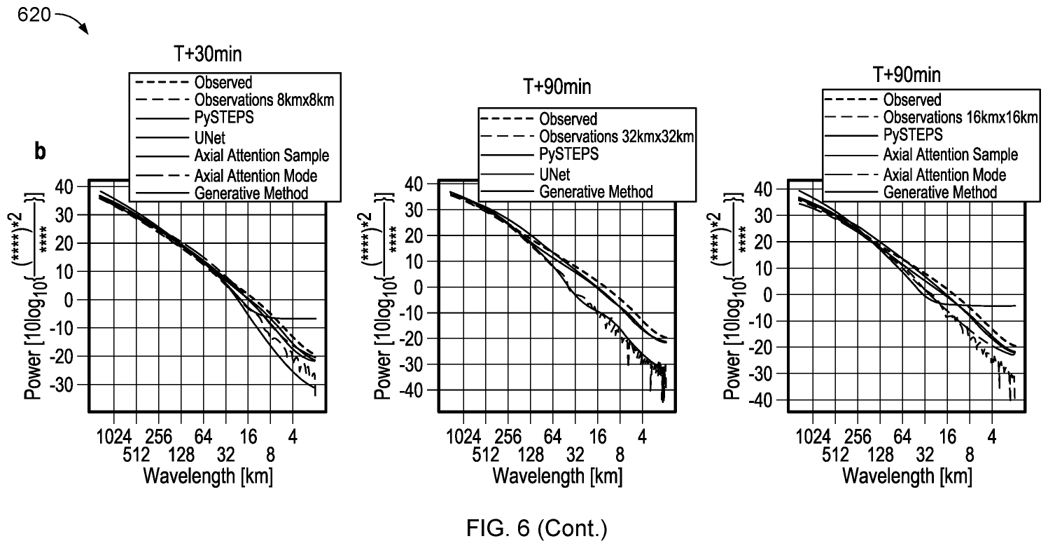

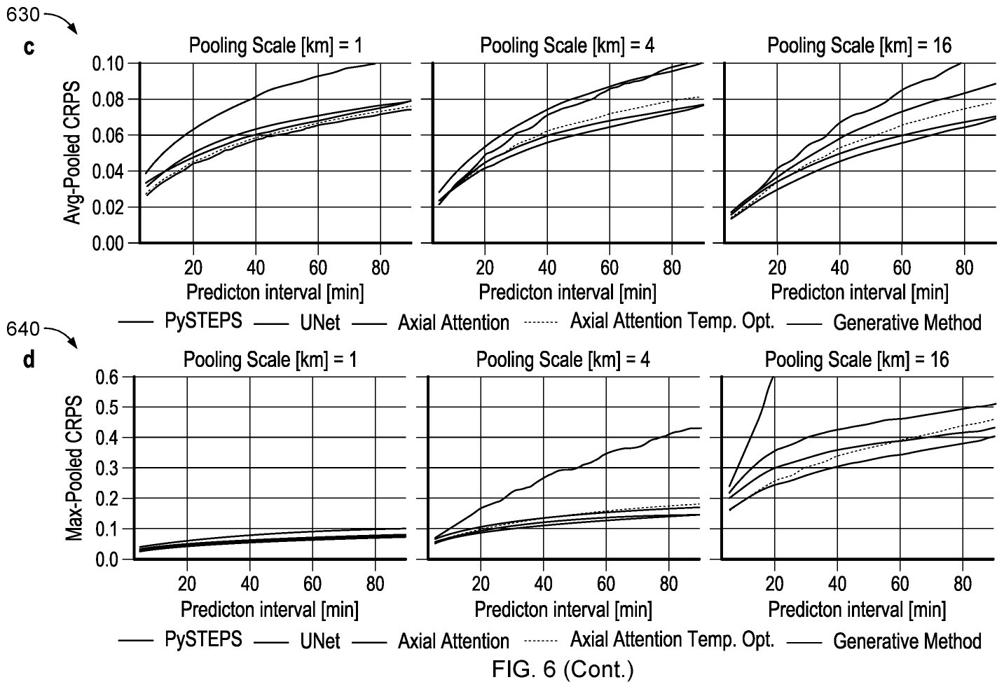

FIG. 4 is a flow diagram of an example process 400 for performing nowcasting for a given real-world location. For convenience, the process 400 will be described as being performed by a system of one or more computers located in one or more locations. For example, a nowcasting system, e.g., the nowcasting system 100 of FIG. 1, appropriately programmed, can perform the 400.

The system obtains a context temporal sequence of a plurality of context radar fields characterizing the given real-world location (step 402).

The system samples a set of one or more latent inputs by sampling values from a specified distribution (step 404).

The system then generates a respective predicted temporal sequence for each latent input in the set. Thus, when there are multiple latent inputs in the set, the system generates multiple different predicted temporal sequences that each represent a different possible realization of the weather at the given real-world location.

To generate a predicted temporal sequence for a given sampled latent input, the system processes the context temporal sequence of radar fields and the sampled latent input using a generative neural network (step 406).

As described above, the generative neural network has been configured through training to process the temporal sequence of radar fields to generate as output a predicted temporal sequence that includes a plurality of predicted radar fields, with each predicted radar field in the predicted temporal sequence characterizing the predicted weather in the real-world location at a corresponding future time point.

FIG. 5 shows a set of observed radar fields 510 relative to predicted radar fields generated by multiple different nowcasting techniques.

In particular, FIG. 4 shows a respective set of predicted radar fields 520, 530, 540, and 550 that are each generated based on context radar fields ending at time T and that each include a respective predicted radar field at time T+30 minutes, T+60 minutes, and T+90 minutes. Each set of predicted radar fields is generated using a different nowcasting technique.

The set 520 is generated using the techniques described in this specification, the set 530 is generated using a PySTEPS nowcasting technique, the set 540 is generated using a UNet-based technique, and the set 550 is generated using an Axial Attention technique.

As can be seen from FIG. 5, the set 520 generated using the described “Generative

Method” is better able to predict the spatial coverage and convection compared to other methods over a longer time period, while not over-estimating the intensities of precipitation. This makes the described techniques much better suited for being used to make operational decision than those generated by other methods. In particular, the outputs of the described methods were significantly preferred by a set of 56 human forecasters, with 93% indicating that the set 520 would be their first choice for use as a nowcast relative to the sets 530-550. This yields a p value of less than 10e-4.

FIG. 6 shows a set of plots of the performance of the described nowcasting techniques relative to other nowcasting techniques: PyTEPS, Unet, Axial Attention, and Axial Attention Model.

The first set of plots 610 shows the performance of the various techniques on a data set in terms of Critical Success Index (CSI) across different precipitation thresholds.

The second set of plots 620 shows the performance of the various techniques on the same data set in terms of radially-averaged power spectral density (PSD) at different time lengths.

Thus, as shown in FIG. 6, while all deep learning methods appear to perform similarly on CSI, the UNet and Axial Attention methods achieve these scores by blurring predictions, as shown in the radially-averaged PSD plot. The spectral properties of the Generative Method, by contrast, mirror the radar observations.

The third set of plots 630 shows the average-pooled continuous ranked probability score (CRPS) of the various techniques across various spatial scales: original predictions (left), average rain rate over a catchment area of size 4 km×4 km (middle) and 16 km×16 km (right).

The fourth set of plots 640 shows the max-pooled continuous ranked probability score (CRPS) of the various techniques across various spatial scales: original predictions (left), average rain rate over a catchment area of size 4 km×4 km (middle) and 16 km×16 km (right).

As can be seen from FIG. 6, the described Generative Method has similarly strong CRPS performance across spatial scales, unlike the baseline models.

As previously described there are many applications for implementations of the system.

In one example application the system may be incorporated into an energy management system. The energy management system may be configured to obtain context radar fields characterizing the weather in a real-world location of a renewable energy generation facility such as a wind power or solar energy generation facility at preceding time points. The context radar fields may be processed as described above, and the renewable energy generation facility, e.g. the wind power or solar energy generation facility, may be controlled in response to the predicted temporal sequence characterizing the predicted weather in the real-world location of the renewable energy generation facility at the corresponding future time point. For example, in a solar energy farm solar panels may be tilted or covered to protect the panels from predicted weather hydrometeors of greater than a threshold severity; or in a wind farm the energy generation facility may be configured to maximize output based on the predicted weather; or one or more other power generation sources on the same electrical grid as the renewable energy generation facility may be controlled to increase or decrease power from the other power generation sources for grid balancing in response to a predicted power output from the renewable energy generation facility based on the predicted weather. In a related energy management system, instead of controlling the renewal energy generation facility, the predicted temporal sequence characterizing the predicted weather in the real-world location of the renewable energy generation facility may be used to send a signal to a consumer of power on the electrical grid to which the renewable energy generation facility is connected, for controlling one or more power-consuming devices of the consumer for load balancing, e.g. in a smart grid, in response to a predicted power output from the renewable energy generation facility based on the predicted weather.

In another example application the system may be incorporated into a flood early-warning system. The flood early-warning system may be configured to obtain context radar fields characterizing the weather in a real-world location of an at-risk area at preceding time points. The context radar fields may be processed as described above; and the flood early-warning system may output a warning, in response to the predicted temporal sequence characterizing the predicted weather in the real-world location of the at-risk area at the corresponding future time point. For example the warning may be provided in response to the predicted weather forecasting greater than a threshold level of precipitation. A similar system may be used to warn of potential landslides. The warning may be issued via one or more channels e.g. television, radio, internet, mobile phones, public transport, or public alarms. In some implementations the warning is a public warning such as an audible and/or visual alarm in the real-world location of the at-risk area that can warn of local danger to life or property.

In another example application the system may be incorporated into an air or marine traffic control system. The air or marine traffic control system may be configured to obtain context radar fields characterizing the weather in a real-world location of one or more air or marine craft at preceding time points. The context radar fields may be processed as described above; and the air or marine traffic control system may output a signal for controlling the flight patterns or marine craft routes of the one or more aircraft or marine craft in the real-world location in response to the predicted temporal sequence characterizing the predicted weather in the real-world location at the corresponding future time point. The signal may be a warning signal or a routing signal; in some implementations it may be automatically provided to the air or marine craft e.g. for the purpose of enabling the air or marine craft to take evasive action. In some implementations system is an air traffic control system and the real-world location may then be the location of an airport. The signal may be output in response to the predicted weather having greater than a threshold level of severity e.g. greater than a threshold level of precipitation or hydrometeors, or greater than a threshold level of wind (speed), or greater than a threshold level of a particular wind behavior (e.g. characterized by wind speed and/or direction).

In another example application the system may be incorporated into an energy management system configured to obtain context radar fields characterizing the weather in a real-world location of a building or industrial facility at preceding time points. The context radar fields may be processed as described above; and control shutters, or a ventilation system, or a temperature control system, of the building or industrial facility in response to the predicted temporal sequence characterizing the predicted weather in the real-world location of the building or industrial facility at the corresponding future time point. Such a system may be used to control a temperature or humidity of the building or industrial facility, or to keep it dry, or to protect the building or industrial facility.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
obtaining a context temporal sequence of a plurality of context radar fields characterizing a real-world location, each context radar field characterizing the weather in the real-world location at a corresponding preceding time point;
sampling a set of one or more latent inputs by sampling values from a specified distribution; and
for each sampled latent input, processing the context temporal sequence of radar fields and the sampled latent input using a generative neural network that has been configured through training to process the temporal sequence of radar fields to generate as output a predicted temporal sequence comprising a plurality of predicted radar fields, each predicted radar field in the predicted temporal sequence characterizing the predicted weather in the real-world location at a corresponding future time point.

2. The method of claim 1, wherein:
each context radar field comprises a respective measured precipitation rate for each of a plurality of grid cells that each correspond to a respective region of the real-world location at a first resolution, wherein the respective measured precipitation rate for each of the grid cells represents a precipitation rate that was measured at the corresponding region at the corresponding preceding time point; and
each predicted radar field comprises a respective predicted precipitation rate for each of the plurality of grid cells that each correspond to a respective region of the real-world location at the first resolution, wherein the respective predicted precipitation rate for each of the grid cells represents a precipitation rate that is predicted to be measured at the corresponding region at the corresponding future time point.

3. The method of claim 1, wherein processing the context temporal sequence of radar fields and the sampled latent input using the generative neural network comprises:
processing the context temporal sequence using a context conditioning convolutional stack to generate a respective context feature representation at each of a plurality of spatial resolutions;
processing the latent input using a latent conditioning convolutional stack to generate a latent feature representation; and
generating the predicted temporal sequence from the context feature representations and the latent feature representation.

4. The method of claim 3, wherein generating the predicted temporal sequence from the context feature representations and the latent feature representation comprises:
for each spatial resolution, initializing a hidden state of a corresponding convolutional recurrent neural network (convRNN) in a sequence of convRNNs that operates at the spatial resolution to be the respective context feature representation at the spatial resolution; and
generating the first predicted radar field at the first future time point in the predicted temporal sequence, comprising:
processing the latent feature representation through the sequence of convRNNs in accordance with the respective hidden states of each of the convRNNs to (i) update the respective hidden states of each of the convRNNs and (ii) generate an output feature representation for the first future time point; and
processing the output feature representation for the first future time point using an output convolutional stack to generate the predicted radar field at the first future time point.

5. The method of claim 4, wherein generating the predicted temporal sequence from the context feature representations and the latent feature representation comprises:
for each future time point in the temporal sequence after the first future time point:
processing the latent feature representation through the sequence of convRNNs in accordance with respective hidden states of each of the convRNNs as of the preceding future time point in the temporal sequence to (i) update the respective hidden states of each of the convRNNs and (ii) generate an output feature representation for the future time point; and
processing the output feature representation for the future time point using the output convolutional stack to generate the predicted radar field at the future time point.

6. The method of claim 1, wherein the generative neural network has been trained jointly with one or more discriminator neural networks on training data that includes sequences of observed radar fields to optimize a generative adversarial networks (GAN) objective.

7. The method of claim 6, wherein the one or more discriminator neural networks include a temporal discriminator neural network that distinguishes sequences of observed radar fields from the training data from sequences of predicted radar fields generated by the generative neural network.

8. The method of claim 6, wherein the one or more discriminator neural networks include a spatial discriminator neural network that distinguishes individual observed radar fields from the training data from individual predicted radar fields generated by the generative neural network.

9. The method of claim 6, wherein the generator neural network and the discriminator neural networks are trained on observed radar fields that have a first dimensionality, wherein after the training the context radar fields received as input by the generator neural network and the predicted radar fields generated by the generator neural network have a second dimensionality, and wherein the first dimensionality is smaller than the second dimensionality.

10. The method of claim 9, wherein during the training, the sampled latent inputs have a smaller dimensionality than the sampled latent inputs after training.

11. The method of claim 10, wherein
the first dimensionality is h₁×w₁×1 and the dimensionality of the sampled latent inputs during training is h₁/a×w₁/a×b,
the second dimensionality is h₂×w2×1 and the dimensionality of the sampled latent inputs during training is h₁a×w2/a×b,
h₂ is larger than h₁, and
w₂ is larger than w₁.

12. The method of claim 1, wherein sampling each latent input comprises: sampling each value in the latent input independently from the specified distribution.

13. The method of claim 1, wherein the set of latent inputs includes a plurality of latent inputs.

14-20. (canceled)

21. One or more non-transitory computer-readable storage media storing instructions that when executed by one or more computers cause the one or more computers to perform operations comprising:
obtaining a context temporal sequence of a plurality of context radar fields characterizing a real-world location, each context radar field characterizing the weather in the real-world location at a corresponding preceding time point;
sampling a set of one or more latent inputs by sampling values from a specified distribution; and
for each sampled latent input, processing the context temporal sequence of radar fields and the sampled latent input using a generative neural network that has been configured through training to process the temporal sequence of radar fields to generate as output a predicted temporal sequence comprising a plurality of predicted radar fields, each predicted radar field in the predicted temporal sequence characterizing the predicted weather in the real-world location at a corresponding future time point.

22. A system comprising one or more computers and one or more storage devices storing instructions that when executed by the one or more computers cause the one or more computers to perform operations comprising:
obtaining a context temporal sequence of a plurality of context radar fields characterizing a real-world location, each context radar field characterizing the weather in the real-world location at a corresponding preceding time point;
sampling a set of one or more latent inputs by sampling values from a specified distribution; and
for each sampled latent input, processing the context temporal sequence of radar fields and the sampled latent input using a generative neural network that has been configured through training to process the temporal sequence of radar fields to generate as output a predicted temporal sequence comprising a plurality of predicted radar fields, each predicted radar field in the predicted temporal sequence characterizing the predicted weather in the real-world location at a corresponding future time point.

23. The system of claim 22, wherein:
each context radar field comprises a respective measured precipitation rate for each of a plurality of grid cells that each correspond to a respective region of the real-world location at a first resolution, wherein the respective measured precipitation rate for each of the grid cells represents a precipitation rate that was measured at the corresponding region at the corresponding preceding time point; and
each predicted radar field comprises a respective predicted precipitation rate for each of the plurality of grid cells that each correspond to a respective region of the real-world location at the first resolution, wherein the respective predicted precipitation rate for each of the grid cells represents a precipitation rate that is predicted to be measured at the corresponding region at the corresponding future time point.

24. The system of claim 22, wherein processing the context temporal sequence of radar fields and the sampled latent input using the generative neural network comprises:
processing the context temporal sequence using a context conditioning convolutional stack to generate a respective context feature representation at each of a plurality of spatial resolutions;
processing the latent input using a latent conditioning convolutional stack to generate a latent feature representation; and
generating the predicted temporal sequence from the context feature representations and the latent feature representation.

25. The system of claim 24, wherein generating the predicted temporal sequence from the context feature representations and the latent feature representation comprises:
for each spatial resolution, initializing a hidden state of a corresponding convolutional recurrent neural network (convRNN) in a sequence of convRNNs that operates at the spatial resolution to be the respective context feature representation at the spatial resolution; and
generating the first predicted radar field at the first future time point in the predicted temporal sequence, comprising:
processing the latent feature representation through the sequence of convRNNs in accordance with the respective hidden states of each of the convRNNs to (i) update the respective hidden states of each of the convRNNs and (ii) generate an output feature representation for the first future time point; and
processing the output feature representation for the first future time point using an output convolutional stack to generate the predicted radar field at the first future time point.

26. The system of claim 25, wherein generating the predicted temporal sequence from the context feature representations and the latent feature representation comprises:
for each future time point in the temporal sequence after the first future time point:
processing the latent feature representation through the sequence of convRNNs in accordance with respective hidden states of each of the convRNNs as of the preceding future time point in the temporal sequence to (i) update the respective hidden states of each of the convRNNs and (ii) generate an output feature representation for the future time point; and
processing the output feature representation for the future time point using the output convolutional stack to generate the predicted radar field at the future time point.

27. The system of claim 22, wherein the generative neural network has been trained jointly with one or more discriminator neural networks on training data that includes sequences of observed radar fields to optimize a generative adversarial networks (GAN) objective.
